(19) United States
(12) Patent Application Publication
(10) Pub. No.: US 2020/0262234 A1
(43) Pub. Date: Aug. 20, 2020

(54) Writing Instrument with Simplified Retracting/Extending Mechanism

(71) Applicant: Paul Thomas Jackson, Huntsville, AL (US)

(72) Inventor: Paul Thomas Jackson, Huntsville, AL (US)

(21) Appl. No.: 16/276,551

(22) Filed: Feb. 14, 2019

(51) Int. Cl. B43K 24/08

(52) U.S. Cl. CPC B43K 24/082

(57) ABSTRACT

A capless, retractable, writing instrument consisting of two distinct actions, one to extend the ink cartridge tip for writing and another distinct action to retract the ink cartridge tip. The writing instrument includes a plunger which is pressed to push the ink cartridge tip outside the body of the pen and a side mounted button retains the extended ink cartridge while writing. The side mounted button is pressed to retract the ink cartridge tip inside the body of the pen for safe storage. The writing instrument contains easily manufactured components.

### BACKGROUND OF THE INVENTION

The invention relates to writing instruments, particularly capless writing pens that extend an ink cartridge tip out of the pen body for use and retract it while not in use, utilizing a mechanism capable of being functioned easily with one hand. Many prior art retractable writing instruments/pens have been patented with the use of intricate interlocking teeth, camming gears, telescoping bodies or levers to facilitate the retracting/extending operation. One downfall of these pens is the elaborate small parts that must be fabricated. Thus the present invention of a writing instrument with a simplified retracting/extending mechanism, for use with one hand, is easily constructed using the most basic of tooling with a minimum number of parts.

### BRIEF DESCRIPTION OF THE INVENTION

This invention is a novel and simplified capless retractable/extendable writing instrument using an ink pen cartridge, but other writing methods such as pencil lead, or a metal scribe are possible. The ink pen cartridge will be used as an example in the embodiment. What makes this capless writing instrument novel and unique is the simplified two action mechanism that allows for the ink cartridge tip to be extended for writing using a top plunger, and a side located button to retract the ink cartridge tip inside the body of the pen. The retraction and extending action can be completed easily with one hand. The purpose of this invention is to allow a retractable/extendable writing instrument to contain only a few simple parts and is one that is more easily manufactured than previous retractable pens.

### BRIEF DESCRIPTION OF THE DRAWINGS

Features and advantages of the embodiment of the present disclosure will become apparent by reference to the following detailed descriptions and drawings.

FIG. 1A is an external overview of the embodiment of the writing instrument according to the present application in an isometric view.

FIG. 1B is an external overview of the embodiment of the writing instrument according to the present application in a side view.

FIG. 2 is an exploded isometric view of the writing instrument.

FIG. 3A is an internal cutaway view of the writing instrument with the ink cartridge retracted within the pen body.

FIG. 3B is a close-up internal cutaway view of the rear section of the writing instrument with the ink cartridge retracted within the pen body.

FIG. 4A is an internal cutaway view of the writing instrument with the ink cartridge extended for writing.

FIG. 4B is a close-up internal cutaway view of the rear section of the writing instrument with the ink cartridge extended for writing.

FIG. 5A is an isometric view of only the button and a ghost drawing of the plunger when the writing instrument is extended.

FIG. 5B is an isometric view of only the button and a ghost drawing of the plunger when the writing instrument is retracted.

### DETAILED DESCRIPTION OF THE INVENTION

In the present application the invention is a hand held capless writing instrument, or pen, which is designed to have the ink cartridge tip extended from the pen body for use and retracted for storage with a one handed action. The embodiment contains a novel and minimalistic mechanism for allowing the ink cartridge tip to be extended by use of a plunger that is pressed and is held in place by a button located at the rear of the pen. The button is pressed to release the ink cartridge tip back inside the pen body.

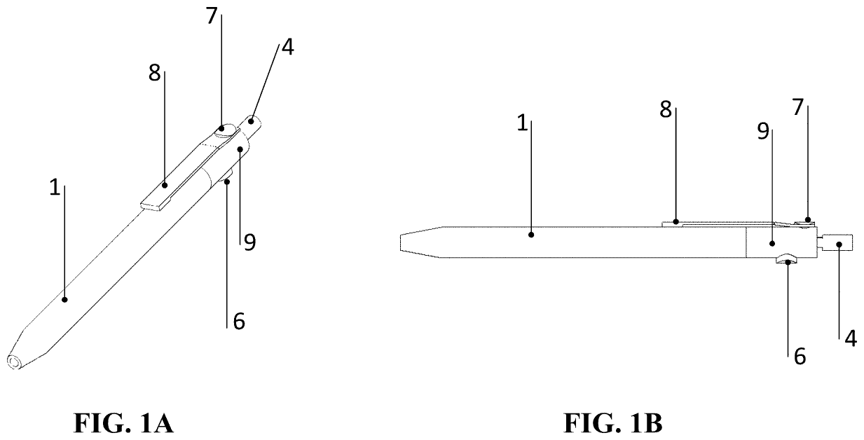

The complete embodiment of the writing instrument with the ink cartridge retracted, as seen externally in FIG. 1A and FIG. 1B, consists of a forward pen body 1, a plunger 4, a button 6, a rear pen body 9 and a pocket clip 8 that is permanently attached to rear body of the pen 9. The pocket clip 8 is attached by using a screw or rivet 7. The forward pen body 1 could also be two separate parts, a tip section and a tubular body.

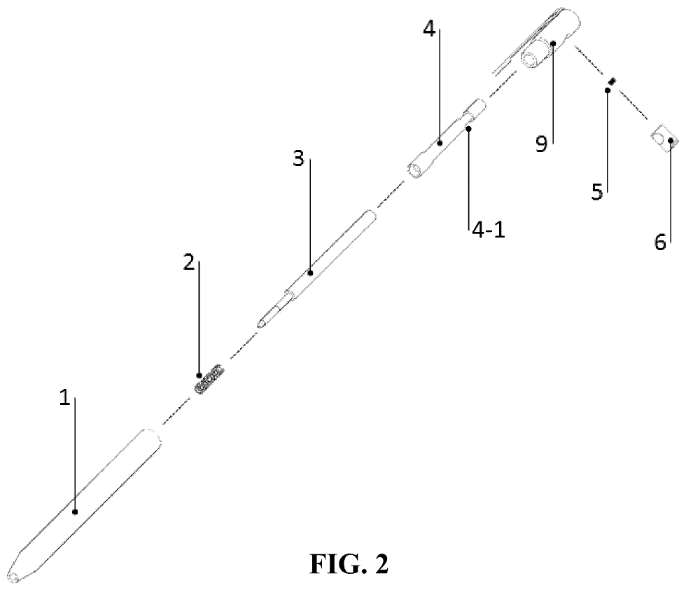

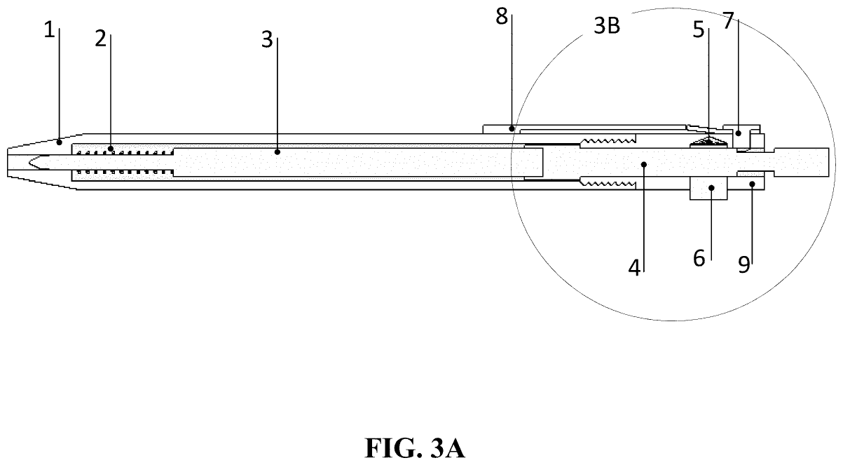

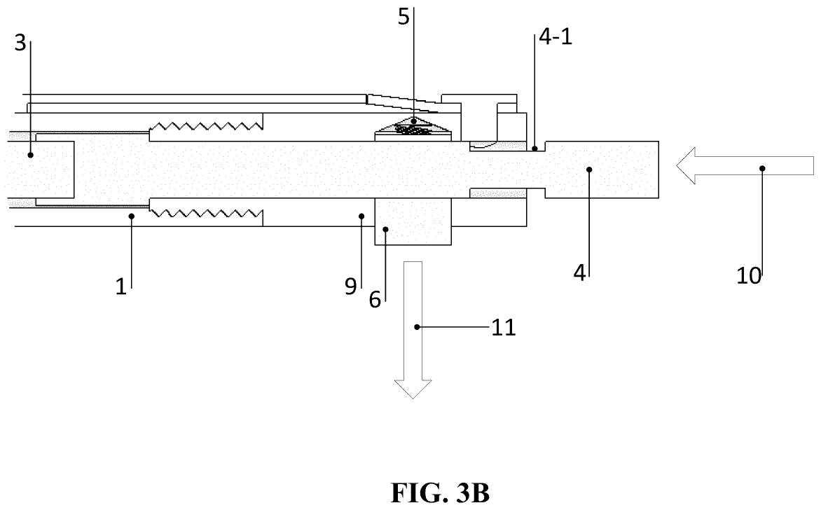

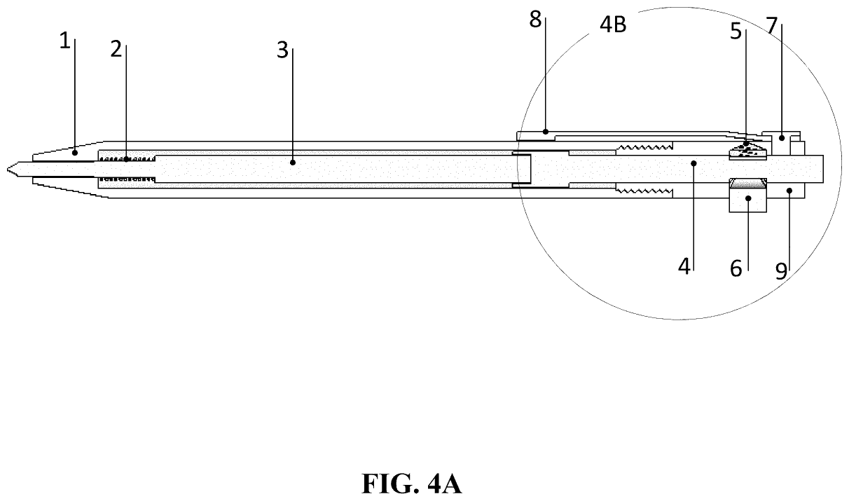

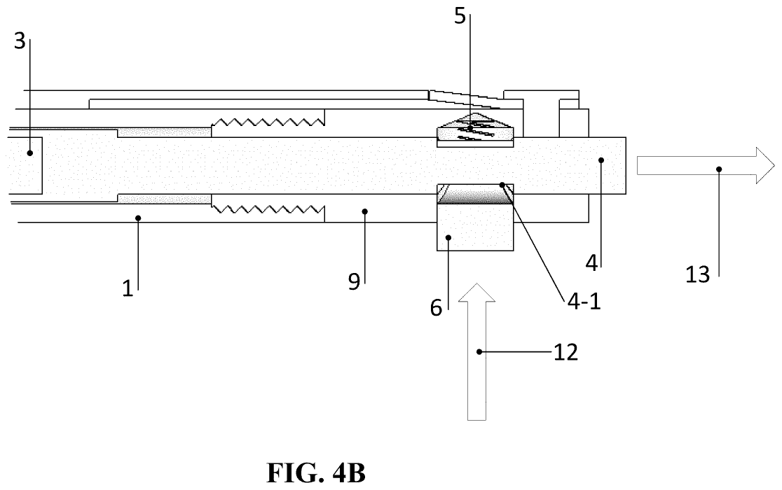

As seen in FIG. 2, FIG. 3A and FIG. 4A the complete writing instrument contains a forward pen body 1 with a forward hole large enough for the tip of the ink cartridge 3 to pass through and a hollow cavity large enough to contain the ink cartridge 3. Placed into the forward pen body 1 is a cartridge spring 2, an ink cartridge 3 and a plunger 4 all of which are held inside the pen body by the rear pen body 9. The cartridge spring 2 is placed onto the forward narrow writing end of the ink cartridge 3 and the plunger 4 is placed behind the ink cartridge. The spring 5 and the button 6 are held within the rear pen body 9 by the plunger 4. The button 6 has a hole in it, perpendicular to the direction that the button is pushed, that allows the plunger 4 to pass through the button 6. The plunger 4 has a forward diameter larger than the diameter of the hole in the rear pen body 9 so the plunger cannot exit the pen body while the forward pen body 1 and rear pen body 9 are attached. The plunger 4 has a rear diameter that allows the rear portion of plunger 4 to pass through the rear pen body 9 and the button 6. The plunger 4 has a recessed ridge 4-1 on it that allows the button 6 to catch on the ridge when the plunger is pushed into pen body. The forward pen body 1 and rear pen body 9 are attached together. The rear pen body 9 contains a hole, parallel to the direction of the ink cartridge 3, which allows the rear portion of the plunger to pass through. The rear pen body 9 contains a hole, perpendicular to the plunger, which allows the button 6 to act upon the plunger 4.

As seen most clearly in FIG. 3B to extend the ink cartridge for usage the plunger 4 is pressed in the direction shown by the arrow 10 into the body of the pen. Once the plunger recessed ridge 4-1 reaches the button 6 a spring 5 behind the button pushes the button 6, in the direction shown by arrow 11, into the recessed ridge 4-1 in the plunger 4 and retains the ink cartridge 3 and plunger 4 in place. At this point the ink cartridge tip has extended outside of the forward pen body 1 and the writing instrument can be used as seen in FIG. 4A.

To retract the ink cartridge tip, as seen in FIG. 4B, the button 6 is pressed inwards, in the direction shown by arrow 12, against the spring 5 until the button 6 has cleared the recessed ridge 4-1 on the plunger 4 then force from the cartridge spring 2 will drive the ink cartridge 3 tip inside the pen body and the plunger 4 back up through the hole in the button 6 and out the rear hole in the rear pen body 9, in the direction shown by arrow 13, and the retracting action is complete. The ink cartridge tip is now securely located inside the forward pen body 1 and the writing instrument can be safely stored, as seen in FIG. 3A. The base of the plunger 4 is larger than the hole within the button 6 and the rear pen body 9, so the plunger 6 cannot pass completely through the rear pen body. While not in use the ink cartridge 3 is held inside the forward pen body 1 by the cartridge spring 2.

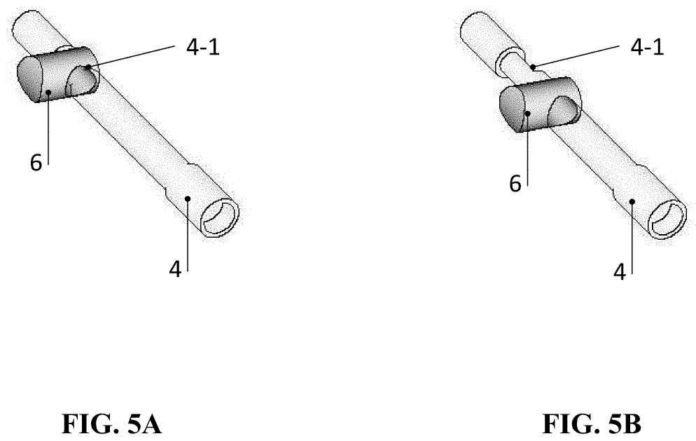

The interaction with the button 6 and the plunger 4 can be clearly seen in FIG. 5A and FIG. 5B. When the pen is extended, as seen in FIG. 5A, the recessed ridge 4-1 of the plunger 4 is retained in position by the hole of the button 6 catching the recessed ridge 4-1. When the button 6 is pressed and the button 6 hole no longer catches the recessed ridge 4-1 the force from the cartridge spring 2 pushes the plunger rearward and the retraction process is complete as seen in FIG. 5B.

The simplified nature of this writing instrument can be seen by the straightforwardness of the components and the minimal number of components.

What is claimed is:

1. A retractable and extendable writing instrument comprising:
a forward pen body with a forward hole that allows an ink cartridge tip to pass through and a cavity large enough to contain an ink cartridge;
a rear pen body with a hole parallel to the ink cartridge to allow a plunger to pass through and a hole perpendicular to the plunger which allows a button to act upon the plunger;
a plunger with a forward diameter larger than the button hole and the rear pen body hole, a rear diameter small enough to pass through the button and rear pen body and has a recessed ridge to be caught by the button;
a ink cartridge and a cartridge spring on the forward end of the ink cartridge that pushes the ink cartridge rearward away from the tip of the writing instrument;
a button with a hole that allows the rear portion of the plunger to pass through and that will catch upon the recessed ridge of the plunger;
a spring for the button;
a. wherein, when the plunger is pushed into the pen body a recessed ridge on the plunger will lock into the hole of the spring loaded button, securing the plunger and securing the ink cartridge tip forward out of the pen body to facilitate writing;
b. wherein, when the spring loaded button is pushed and the button no longer catches the recessed ridge of the plunger the cartridge spring will force the ink cartridge tip into the pen body and the rear of plunger back out the rear pen body to facilitate safe storage;
c. wherein, the base of the plunger has a larger diameter than the rear pen body hole to keep the plunger within the pen body;
d. wherein, when the pen is not in use the ink cartridge tip is held inside the pen body by the cartridge spring;
e. wherein, the forward and rear pen bodies connect together.

2. The writing instrument of claim 1 further includes a pocket clip permanently attached to the pen body.

3. The writing instrument of claim 1 in which the forward pen body consists of two separate parts a tip and a tubular body.

4. The writing instrument of claim 1 in which the ink pen cartridge of the pen is a ball-point, felt, or gel-ink pen.

5. The writing instrument of claim 1 in which the ink pen cartridge of the pen is a pencil lead mechanism.

6. The writing instrument of claim 1 in which the ink pen cartridge of the pen is a metal scribe writing mechanism.
